(19) United States
(12) Patent Application Publication
(10) Pub. No.: US 2007/0056945 A1
(43) Pub. Date: Mar. 15, 2007

(54) Welding torch having nozzle assembly with independently removable components

(75) Inventor: Rob van der Hammen, Kleve (DE)

Correspondence Address: Tait R. Swanson, FLETCHER YODER, P. O. Box 692289, Houston, TX, 77269-2289, US

(73) Assignee: Illinois Tool Works Inc.

(21) Appl. No.: 11/517,910

(22) Filed: Sep. 8, 2006

Related U.S. Application Data
(60) Provisional application No. 60/716,360, filed on Sep. 11, 2005.

(51) Int. Cl. B23K 9/173

(52) U.S. Cl. 219/137.43

(57) ABSTRACT

Embodiments of an insulated sleeve and a perforated screen may be used in a nozzle assembly for a welding torch. In one embodiment, a welding system includes an electrically insulated sleeve and a perforated screen disposed adjacent to the electrically insulated sleeve. The perforated screen is configured to be captured removably between a nozzle and a contact tip of a torch head, and the perforated screen is configured to be installed and removed independent of the nozzle.

### REFERENCE TO RELATED APPLICATION

This application claims the benefit of U.S. Provisional Application No. 60/716,360, filed on Sep. 11, 2005.

### BACKGROUND

The invention relates generally to welding systems and, more particularly to, a wire-feed welding gun.

Welding is a method of joining, or separating, metal objects. Arc welding is a common type of welding. An arc welding system typically is comprised of a power supply coupled by an electrical cable to a welding gun housing an electrode. A ground cable is used to connect the metal object to the power supply. When the electrode is placed against the metal object, the electrode in the welding handle completes an electrical circuit between the power supply and the metal object, allowing electrical current to flow through the electrode and metal object. The electrical current produces an arc between the electrode and the metal object. The heat of the electric arc melts the metal object in the region surrounding the electric arc. A filler material may be added to the molten metal. For example, a wire may be placed against the molten portion of the object, melting the wire and allowing the molten wire to merge with the molten object. Once the electrode is drawn away from the metal object, the circuit is broken and the molten mass begins to cool and solidify, forming a weld.

MIG (Metal Inert Gas) welding is one type of arc welding. MIG welding is also referred to as “wire-feed” or GMAW (Gas Metal Arc Welding). In MIG welding, a metal wire is used as the electrode. The wire is shielded by an inert gas and the metal wire acts as the filler for the weld. The inert gas is used to shield the molten metal from outside contaminants and gases that may react with the molten metal. Non-inert gases, such as CO₂, may also be used in MIG welding.

Unfortunately, the molten metal can splatter into the head assembly of the welding torch, causing the components to bind when disassembly is desired for maintenance, repair, and so forth. For example, molten metal can splatter onto threads in a generally interior portion of the head assembly. As a result, the components may not be easily disassembled for replacement of wear items, such as contact tips. If the components cannot be disassembled for servicing or replacement, then at least part of the assembly may be discarded along with expensive insulation disposed inside.

### BRIEF DESCRIPTION

Embodiments of the present invention enable disassembly of a torch head despite metal splatter onto the components. In other words, the components of the torch head may be assembled in a matter that generally reduces the likelihood that components could become irrevocably bound together. In some embodiments, the components that potentially could become bound together may be mounted independently from one another, such that if a first component becomes bound by metal splatter then a second component can be removed nevertheless. For example, certain components may be captured without threads between other components. In one embodiment, a contact tip is captured between a nozzle and a diffuser. In another embodiment, an insulated sleeve and a perforated screen are captured between the nozzle and the diffuser. In a further embodiment, the contact tip is captured between the perforated screen and the diffuser, and the insulated sleeve is captured between the perforated screen and the nozzle.

### DRAWINGS

These and other features, aspects, and advantages of the present invention will become better understood when the following detailed description is read with reference to the accompanying drawings in which like characters represent like parts throughout the drawings, wherein:

FIG. 1 is a diagram of a MIG welding system, according to an exemplary embodiment of the present technique;

FIG. 2 is a front elevational view of a MIG welding gun, according to an exemplary embodiment of the present technique;

FIG. 3 is an exploded view of the nozzle assembly of the MIG welding gun of FIG. 2, illustrating the nozzle, perforated screen, insulated sleeve, and contact tip;

FIG. 4 is cross-sectional views of the nozzle assembly, illustrating the manner in which the insulated sleeve and perforated screen are captured between the nozzle and contact tip;

FIG. 5 is an exploded cross-sectional view of the nozzle assembly, illustrating the method for accessing and quickly replacing the contact tip.

### DETAILED DESCRIPTION

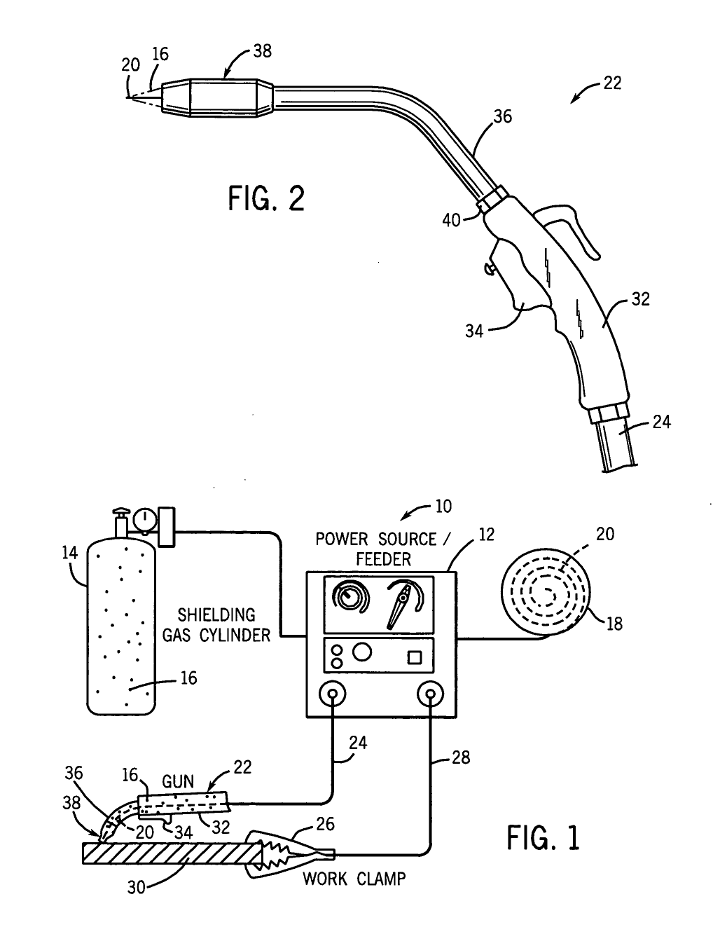

Referring generally to FIG. 1, an exemplary metal inert gas (“MIG”) welding system 10 is illustrated. However, the present technique may be used in other wire feed welding systems, such as submerged arc welding. The illustrated MIG welding system 10 comprises a power source/wire feeder 12, a gas cylinder 14 containing a gas 16, a spool 18 of electrode wire 20, a welding gun 22, a welding cable 24, a work clamp 26, and a ground cable 28. In the illustrated embodiment, the gas 16 and wire 20 are routed from the power source/wire feeder 12 to the welding cable 24. The welding cable 24, in turn, routes the gas 16 and the wire 20 to the welding gun 22. The power source/wire feeder 12 also may be comprised of a separate power source and a separate wire feeder.

The welding cable 24 also has conductors for conveying large amounts of electric current from the power source/wire feeder 12 to the welding gun 22. The power source/wire feeder 12 is operable to control the feeding of wire 20 to the welding gun 22. In addition, the power source/wire feeder 12 may be used to control the flow of gas 16 to the welding gun 22. To assemble the system, a ground cable 28 having a clamp 26 is connected to the power source/wire feeder 12. The clamp 28 is clamped onto a workpiece 30 to electrically couple the workpiece 30 to the power source/wire feeder 12. Additionally, the wire 20 within the MIG welding cable 24 may be electrically coupled to the power source/wire feeder 12.

The welding gun 22 is used to direct the wire 20 towards the workpiece 30. When the wire is touched to the workpiece, an electrical circuit between the workpiece and power source/wire feeder 12 is completed. Electric current flows from the power source through the welding cable 24, the electrode wire 20, the workpiece 30, the workclamp 26, and the ground cable 28 back to the power source 12. An arc is produced between the electrode wire 20 and the workpiece 30. The electric arc melts the workpiece 30 in a region surrounding the arc, forming a weld puddle. The heat of the arc melts the wire 20 along with the workpiece 30, enabling the electrode wire to act as a filler material for the weld puddle. The inert gas 16 forms a shield that prevents harmful chemical reactions from occurring at the weld puddle. When the arc is removed, the weld puddle solidifies, forming the weld.

Referring generally to FIGS. 1 and 2, the welding gun 22 comprises a handle 32, a trigger 34, a neck 36, and a head or nozzle assembly 38. The neck 36 is secured to the handle 32 by a locking nut 40. The MIG welding cable 24 also has an electrical cable that is electrically coupleable to the trigger 34. The trigger 34 enables a user to control the supply of electrode wire 20 and power from the power source/feeder 12. A number of events occur when the trigger 34 is operated. One event is that the power source/wire feeder 12 draws in wire 20 from the wire spool 18 and feeds it though the MIG welding cable 24 to the welding gun 22. Also, electric power from the power source/feeder 12 is supplied to the wire 20. The welding gun 22 may be adapted to enable the flow of gas 16 from the gas cylinder 14 to be controlled by the trigger 34. The wire 20 and gas 16 are then fed through the neck assembly 36 towards the workpiece 30. The nozzle assembly 38 directs the wire 20 and gas 16 towards the target workpiece 30. When the trigger 34 is released, the wire 20 and electric current are no longer fed to the welding gun 22.

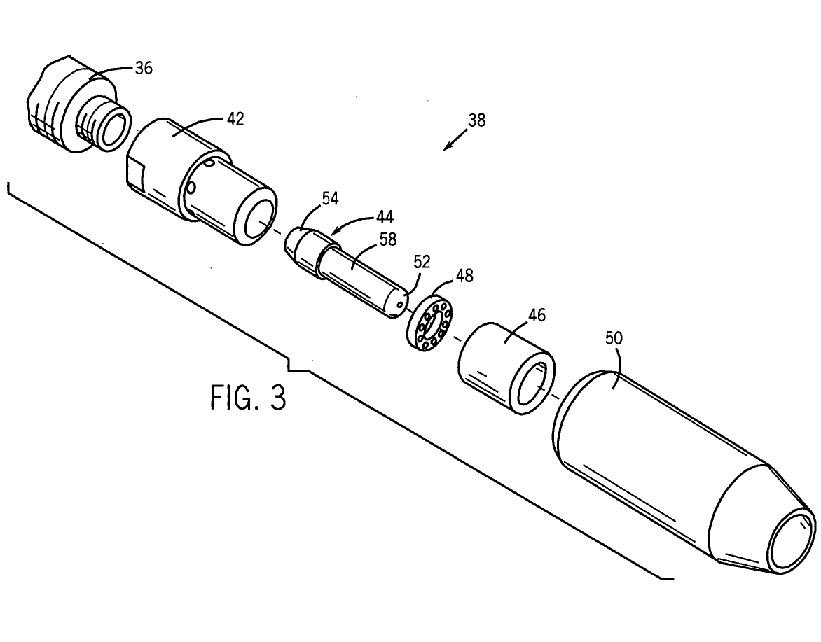

Referring generally to FIGS. 2 and 3, the nozzle assembly 38 comprises a gas diffuser 42, a contact tip 44, an electrically insulated sleeve 46, a perforated screen 48, and a nozzle 50. As discussed below, the contact tip 44, the sleeve 46, and the screen 48 are generally captured without threads (i.e., non-threaded engagement) between the nozzle 50 and the neck 36. In other words, the nozzle 50 mates with the neck 36 to compressively retain or capture the contact tip 44, sleeve 46, and screen 48 in the space between the gas diffuser 42 and the nozzle 50. More specifically, the contact tip 44 is compressively retained or captured between the diffuser 42 and the screen 48, the screen 48 is compressively retained or captured between the contact tip 44 and the sleeve 46, and the sleeve 46 is compressively retained or captured between the screen 48 and the nozzle 50. Each of these captured relationships is without threads. As a result, the nozzle 50, the sleeve 46, the screen 48, and the contact tip 44 may be removed one after another in a generally independent manner. Thus, if metal spatter binds the screen 48 to the contact tip 44, then the user can still remove the nozzle 50 and the sleeve 46 to gain access to the contact tip 44. Accordingly, the user can gain access to the bound screen 46 and contact tip 44, thereby simplifying the disassembly. If the screen 46 remains bound to the contact tip 44, then the user can simply discard the contact tip 44 along with the screen 46 without the more costly/non-wear items such as the insulated sleeve 46.

Given that the nozzle 50 mates with the neck 36 rather than the gas diffuser 42, the welding torch 22 may remain cooler than previous designs, thereby enabling the torch 22 to operate at higher welding amperages without substantially more heat than previous designs. In other words, the heat may be distributed over a greater area or volume of the entire torch, thereby increasing heat dissipation away from the torch 22. In addition, the neck 36 of the torch 22 may be cooled to further improve heat dissipation. For example, one or more passages of water or another fluid coolant may circulate along the neck 36 of the torch 22. By further example, the neck 36 of the torch 22 may embody a liquid coolant system, such as a water coolant system having passages leading to and from a pump, radiator, fans, and so forth. However, in some embodiments, the nozzle 50 may couple directly to the gas diffuser 42.

Gas flows from the welding cable 24 through the handle 32 and neck 36 into to the gas diffuser 42. The gas diffuser 42 is used to establish desired flow characteristics of the gas 16. The nozzle 50 is used to direct the gas 16 from the gas diffuser 42 towards the workpiece 30. The contact tip 44 is used to direct the wire from the welding gun 22 and to conduct electric current from the welding cable 24 to the electrode wire 20. The large amounts of electric current drawn from a typical power source/wire feeder 12 during welding could damage the electrode wire if the electric current was conducted through the entire length of the electrode wire. Therefore, the welding cable 24, rather than the electrode wire, is used to conduct most, if not all, of the electric current from the power source/wire feeder 12 to the welding gun 22. The contact tip 44 is used to transfer the electric current flowing through the welding cable 24 to the electrode wire 20. The contact tip 44 is electrically coupled to the welding cable 24 by the neck 36 and the gas diffuser 42.

In the illustrated embodiment, the contact tip 44 is secured within the welding gun 22 by abutment with the gas diffuser 42 and nozzle 50, rather than by threading the tip into the gas diffuser. Thus, the contact tip 44 is generally captured between the gas diffuser 42 and the nozzle 50 via a threadless interface on the contact tip 44 (i.e., without threads). Moreover, the nozzle 50 is configured to mate with the neck 36 independently from the contact tip 44 via threads or another non-threaded fastening mechanism. The contact tip 44 has a channel 52 that extends through the length of the contact tip 44 that is used to direct the electrode wire 20 through the contact tip 44. In addition, the channel 52 is used to bring the electrode wire 20 into contact with the contact tip 44 so that electric current may be conducted from the contact tip 44 to the electrode wire 20. In the illustrated embodiment, the channel 52 defines an axis extending linearly through the contact tip 44, the gas diffuser 42, and the nozzle 50. In addition, in this embodiment, the contact tip 44 is symmetrical about the axis.

Since large amounts of electrical current flow through the contact tip 44, the nozzle 50 is typically electrically isolated from the contact tip 44. The insulated sleeve 46 accomplishes this function in the illustrated embodiment. The insulated sleeve 46 may comprise a high temperature plastic, a ceramic, a ceramoplastic, or a combination thereof, in order to provide the desired insulation properties. However, the sleeve 46 is not limited to these materials. Moreover, the sleeve 46 generally reduces the volume or general amount of insulation material, because the sleeve 46 extends along a relatively small portion (e.g., less than 10, 20, 30, 40, or 50 percent) of the entire length of the nozzle 50. Given the relatively high cost of insulation material, the smaller volume (e.g., 10 percent of the material used in U.S. Pat. No. 6,852,950) generally reduces the cost of the nozzle assembly 38. Finally, the sleeve 46 is generally cylindrical and may be configured with an inner mount or radial step to locate the perforated screen 48. In other words, the radial step may include a first annular portion leading to a second annular portion, wherein the second annular portion has a larger diameter than the first annular portion. As discussed below, the screen 48 generally abuts the tip 44 at the radial step. However, variations could be made to the geometry without functionally changing the illustrated embodiment.

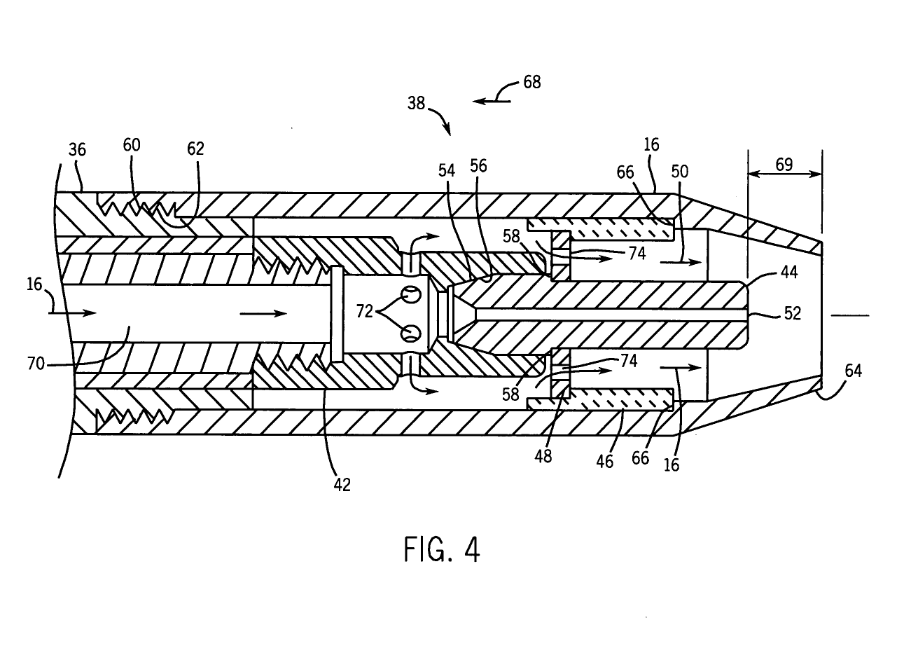

As illustrated in FIG. 4, the contact tip 44 has an end surface 54 that is adapted to abut and mate with a seating surface 56 of the gas diffuser 42 without threads. The contact tip 44 also includes a collar or shoulder 58 that extends around the contact tip 44 for engagement with the nozzle 50 without threads. The nozzle 50 biases the tip 44 toward the diffuser 42 via the insulated sleeve 46 and the perforated screen 48 disposed between the nozzle 50 and the tip 44. In other words, as the nozzle 50 fastens (e.g., threads) onto the diffuser 42, the nozzle 50 biases the sleeve 46 toward the screen 48, the sleeve 46 biases the screen 48 toward the tip 44, and the screen 48 biases the tip 44 toward the diffuser 42.

In the illustrated embodiment, the end surface 54 is uniform around the contact tip 44. The end surface 54 of the contact tip 44 and the seating surface 56 of the gas diffuser 42 are adapted for sealing engagement to prevent gas from escaping between the gas diffuser 42 and the contact tip 44. In the illustrated embodiment, the end surface 54 and the seating surface 56 are tapered to have a generally conical shape. However, the end surface 54 and the seating surface 56 may be curved or otherwise configured for mutual abutment and/or for sealing engagement without threads.

In the illustrated embodiment, the shoulder 58 protrudes from the contact tip 44 and is adapted to be abutted. In this embodiment, the shoulder 58 is uniform around the contact tip 44. The shoulder 58 extends around the entire circumference of the contact tip 44 and is transverse to the axis of the contact tip 44 so as to be in facing relationship with the annular portion of the nozzle 50 and the perforated screen 48. The contact tip 44 may be adapted with other types of protrusions or mounting portions, such as tabs, flanges, spokes, or geometries that can abut and limit axial movement of the screen 48 and the sleeve 46. For example, the contact tip 44 may be adapted with a plurality of separate protrusions spaced at various locations around the circumference of the contact tip 44. In addition, a securing member, such as a retaining ring or snap ring, may be secured to the tip 44 to act as a protrusion.

In the illustrated embodiment, the nozzle 50 is removably secured to the welding gun via a threaded portion 60 of the nozzle 50 that engages a threaded portion 62 of the neck 36. The nozzle 50 also has a conical portion 64 for directing the flow of gas 16 towards the workpiece 30. Alternate embodiments for the end portion of the nozzle are set forth in U.S. Pat. No. 6,852,950, which is hereby incorporated by reference. In the illustrated embodiment, the nozzle 50 has an annular portion 66 that is adapted for engagement with the insulated sleeve 46, which is adapted for engagement with the perforated screen 48 to bias the contact tip 44 toward the gas diffuser 42. The illustrated perforated screen 48 has a disc-like or washer-shaped structure and has an opening 68 configured to receive the contact tip 44. The perforated screen 48 may comprise a metal, a ceramic, a cermet, or other material that can provide the desired functionality.

The electrically insulated sleeve 46 and perforated screen 48 are disposed between the contact tip 44 and the nozzle 50 prior to securing the nozzle 50 to the gas diffuser 42. Because the illustrated embodiment is uniform about the axis, the contact tip 44, electrically insulated sleeve 46, and perforated screen 48 may be disposed between the gas diffuser 42 and nozzle 50 in any rotational orientation. The nozzle 50 is drawn toward the gas diffuser 42 as the nozzle 50 is threaded onto the neck 36, as indicated by reference numeral 68. The annular portion 66 of the nozzle 50 abuts the insulated sleeve 48, which then abuts the screen 48 to bias the shoulder 58 of the contact tip 44 axially against the gas diffuser 42. This brings the end surface 54 of the contact tip 44 into abutment with the seating surface 56 of the gas diffuser 42. As a result, the attachment of the nozzle 50 to the neck 36 captures the contact tip 44, perforated screen 48, and insulated sleeve 46 between the gas diffuser 42 and the nozzle 50 without threads between these components 42, 44, 46, and 48. The illustrated annular portion 66 of the nozzle 50 extends around the inner circumference to uniformly load the insulated sleeve 46. As a result of this capture mechanism, a consistent tip-recess distance, as indicated by reference number 69, is maintained by configuring the parts to abut in the same manner each time the components 42, 44, 46, 48, and 50 are coupled together with the neck 36 of the welding torch. Furthermore, in the illustrated embodiment, the perforated screen 48 may be the only metallic element in contact with the tip, thereby minimizing resistive losses and increasing the life and efficiency of the welding system. Moreover, if the screen 48 becomes bound to the contact tip 44 via splattered metal, then the relatively small screen 48 and the tip 44 can be discarded and replaced independently from the other components, e.g., nozzle 50, sleeve 46, and so forth.

Referring generally to FIG. 4, gas 16 enters the gas diffuser 42 from the neck 36 via an entrance chamber 70. In the illustrated embodiment, the gas diffuser has a plurality of exit holes 72 for the gas to exit the gas diffuser 42. In addition, the screen 48 is perforated creating a plurality of gas delivery holes 74. The gas delivery holes 74 enable gas 16 to pass through the screen and enter the conical portion 60 of the nozzle 50. The gas delivery holes 74 of the illustrated embodiment comprise a circular array of circular perforation that extend in parallel to the contact tip 44, allowing for improved flow characteristics of the gas 16 flowing from the nozzle 50. However, the gas delivery holes 74 are not limited to the circular array, circular shape, or orientation illustrated and may be altered for a particular application.

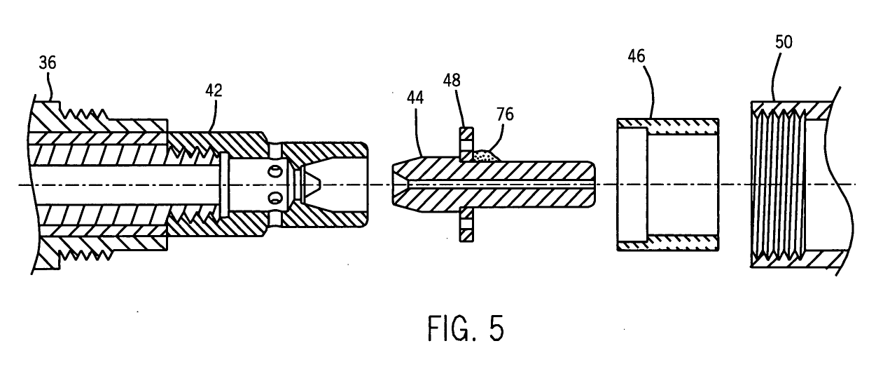

FIG. 5 illustrates the process of replacing the contact tip 44 and a benefit of having the perforated screen 48 and insulated sleeve 46 independent from the nozzle 50. As discussed above, because of its proximity to the weld location, the contact tip 44 may be exposed to weld splatter and relatively high-levels of heat. Accordingly, the figure illustrates a contact tip 44 that has weld splatter 78 built up on a portion of the outside diameter. The elements are shown as they may appear upon removal of the nozzle assembly 38 from the welding gun. The contact tip 44, the insulated sleeve 46, and the perforated screen 48 are directly accessible upon disassembly of the nozzle 50 from the neck 36. As a result, an operator can gain access to the weld splatter 76 on the contact tip 44, thereby enabling the operator to quickly replace the tip 44 without the use of tools. Furthermore, since the parts are independent elements, the operator is not required to scrap an entire nozzle assembly if one of the elements is no longer operable.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A welding system, comprising:
an electrically insulated sleeve; and
a perforated screen disposed adjacent to the electrically insulated sleeve, wherein the perforated screen is configured to be captured removably between a nozzle and a contact tip of a torch head, and the perforated screen is configured to be installed and removed independent of the nozzle.

2. The welding system of claim 1, wherein the electrically insulated sleeve comprises a generally cylindrical body having an inner mount portion, and the perforated screen is disposed in the generally cylindrical body at the inner mount portion.

3. The welding system of claim 2, wherein the inner mount portion comprises a radial step generally about an inner perimeter of the generally cylindrical body.

4. The welding system of claim 1, wherein the electrically insulated sleeve comprises a ceramic material, or a high temperature thermoplastic material, or a combination thereof.

5. The welding system of claim 1, wherein the perforated screen comprises a disc-shaped portion having an opening configured to receive the contact tip.

6. The welding system of claim 1, wherein the perforated screen comprises a plurality of circular perforations, a circular array of perforations, or a combination thereof.

7. The welding system of claim 1, wherein the perforated screen comprises a metallic material.

8. The welding system of claim 1, comprising the nozzle, or the contact tip, or a gas diffuser configured to receive the contact tip, or a combination thereof.

9. The welding system of claim 1, comprising the torch head having the perforated screen captured removably between the nozzle and the contact tip.

10. The welding system of claim 9, wherein the electrically insulated sleeve is captured removably between the nozzle and the perforated screen.

11. The welding system of claim 9, wherein the contact tip is captured removably between the perforated screen and a gas diffuser.

12. The welding system of claim 11, wherein the nozzle is disposed about the contact tip, the electrically insulated sleeve, the perforated screen, and the gas diffuser.

13. The welding system of claim 12, where the nozzle is threadably secured to the torch head.

14. The welding system of claim 11, wherein the contact tip is attached to the gas diffuser via a threadless interface.

15. The welding system of claim 11, wherein the perforated screen abuts a shoulder of the contact tip.

16. The welding system of claim 1, comprising the nozzle coupled to a torch body having the head.

17. The welding system of claim 16, wherein the torch body comprises a liquid coolant system.

18. A welding system, comprising:
an electrically insulated sleeve configured to be captured axially between a nozzle and a gas diffuser of a welding torch, wherein the electrically insulated sleeve is configured to be installed and removed independent of the nozzle.

19. The welding system of claim 18, comprising a contact tip configured to pass through a perforated screen and abut the gas diffuser via the electrically insulated sleeve abutting the perforated screen.

20. The welding system of claim 18, wherein the electrically insulated sleeve comprises a generally cylindrical body having a stepped inside diameter configured to support a perforated screen.

21. The welding system of claim 18, wherein the electrically insulated sleeve comprises a ceramic material, or a high temperature plastic, or a ceramoplastic, or a combination thereof.

22. A welding system, comprising:
a perforated screen configured to be captured between a nozzle and a gas diffuser of a torch head, wherein the perforated screen is configured to be disposed about a contact tip of the torch head and the perforated screen is configured to be removed independent of the nozzle.

23. The welding system of claim 22, wherein the perforated screen comprises a washer-shaped structure.

24. The welding system of claim 22, wherein the perforated screen has a plurality of circular perforations distributed in a circular array.

25. A method of disposing a contact tip against a gas diffuser of a welding torch, comprising;
disposing a perforated screen about the contact tip against a shoulder of the contact tip;
disposing an electrical insulator adjacent to the perforated screen; and
capturing the electrical insulator, the perforated screen, and the contact tip between the diffuser and a nozzle of the welding torch.

26. The method of claim 20, comprising threadably securing the nozzle to welding torch.
